(19) United States
(12) Patent Application Publication
(10) Pub. No.: US 2009/0037339 A1
(43) Pub. Date: Feb. 5, 2009

(54) Methods of authenticating a bank customer desiring to conduct an electronic check deposit transaction

(75) Inventors: Michael Ancell, Kitchener (CA); Peter H. Robinson, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/888,682

(22) Filed: Aug. 2, 2007

(51) Int. Cl. H04K 1/00

(52) U.S. Cl. 705/72

(57) ABSTRACT

A method is provided of a bank authenticating a bank customer desiring to electronically deposit at least one check. The method comprises receiving a secret password from the bank customer, retrieving information relating to the bank customer, receiving an image of a security document which has been optically scanned by the bank customer, extracting information from the image of the physical security document, and authenticating the bank customer when both the secret password received from the bank customer and the extracted information from the image of the security document match the retrieved information relating to the bank customer.

### BACKGROUND

The present invention relates to authenticating bank customers, and is particularly directed to methods of authenticating a bank customer desiring to conduct an electronic check deposit transaction.

In a typical electronic check deposit transaction between a bank customer and a bank, the bank customer logs onto a remote check image capture client. The bank customer enters a personal identification number (“PIN”) in response to being prompted to enter a PIN. The bank customer is authenticated when the PIN entered by the bank customer matches information contained in a bank customer database. After authentication, the bank customer is allowed to conduct the electronic check depositing transaction. It would be desirable to provide improved methods of the bank authenticating the bank customer before the bank customer is allowed to conduct the electronic check deposit transaction.

### SUMMARY

In accordance with one embodiment of the present invention, a method is provided of a bank authenticating a bank customer desiring to electronically deposit at least one check. The method comprises receiving a secret password from the bank customer, retrieving information relating to the bank customer, receiving an image of a security document which has been optically scanned by the bank customer, extracting information from the image of the physical security document, and authenticating the bank customer when both the secret password received from the bank customer and the extracted information from the image of the security document match the retrieved information relating to the bank customer.

### BRIEF DESCRIPTION OF THE DRAWINGS

In the accompanying drawings:

FIG. 1 is a block diagram of a remote check image capture system;

FIG. 2 is a flowchart illustrating a process flow of a bank customer in the remote check image capture system of FIG. 1; and

FIG. 3 is a flowchart illustrating steps of a customer authorization program in the remote check image capture system of FIG. 1.

### DETAILED DESCRIPTION

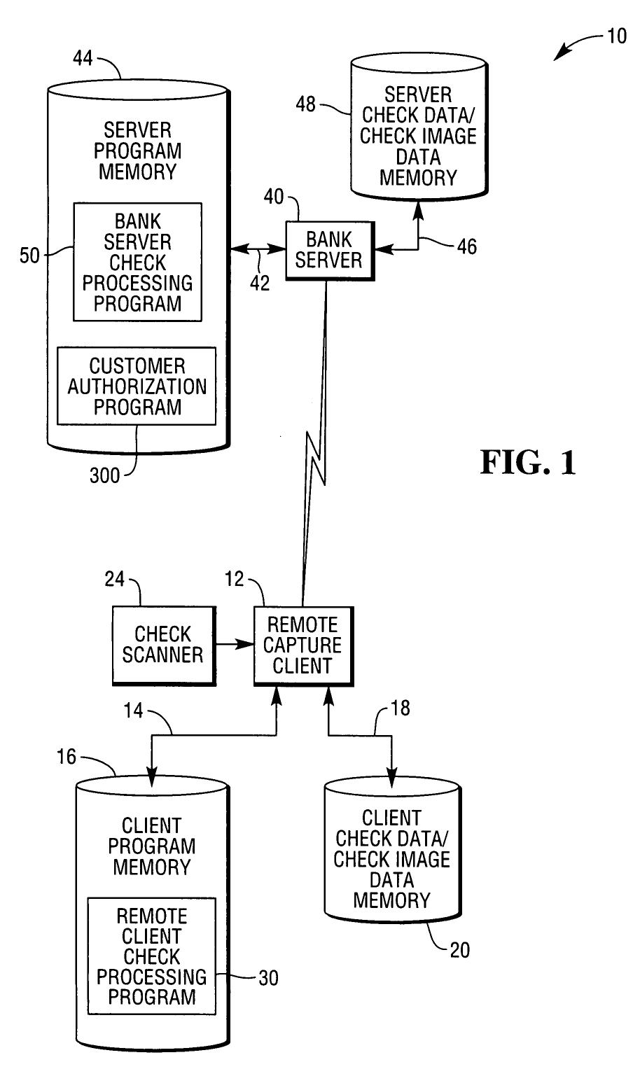

The present invention is directed to methods of authenticating a bank customer desiring to conduct an electronic check deposit transaction. Referring to FIG. 1, a remote check image capture system 10 includes a remote capture client 12 which communicates via line 14 with a client program memory 16 and via line 18 with a client check data/check image data memory 20. The client program memory 16 stores a number of application programs including a remote client check processing program 30. The client check data/check image data memory 20 stores check data and check image data which is representative of captured images of checks. The remote capture client 12 may comprise a conventional desktop computer with a graphical user interface. Suitable computers and graphical user interfaces are readily available in the marketplace. Their structure and operation are well known and, therefore, will not be described.

The remote check image capture system 10 further includes a check scanner device 24 for scanning checks and capturing images of scanned checks. The check scanner device 24 may comprise any type of optical scanner in which either the check is moved past the scanner or the scanner is moved past the check. As an example, the check scanner device 24 may be located at a commercial facility where check processing functions are performed. As another example, the check scanner device 24 may be located in a person's home or place of business where typical off-the-shelf types of optical scanners would be available for lifting images of physical checks as the physical checks are scanned.

During operation, the check scanner device 24 lifts an image of a check when the check is moved past the check scanner device. Lifted check images are stored in the client check data/check image data memory 20. The process of lifting an image of a check using the check scanner device 24, and then storing the lifted check image in the client check data/check image data memory 20 are known and, therefore, will not be described.

Lifted images of checks are transmitted to a bank server 40 for further processing at the bank server facility. The bank server 40 communicates via line 42 with a server program memory 44 and via line 46 with a server check data/check image data memory 48. The server program memory 44 stores a number of application programs including a bank server check processing program 50 and a customer authorization program 300 to be described in detail later. The server check data/check image data memory 48 stores check image data and check data received from the remote capture client 12.

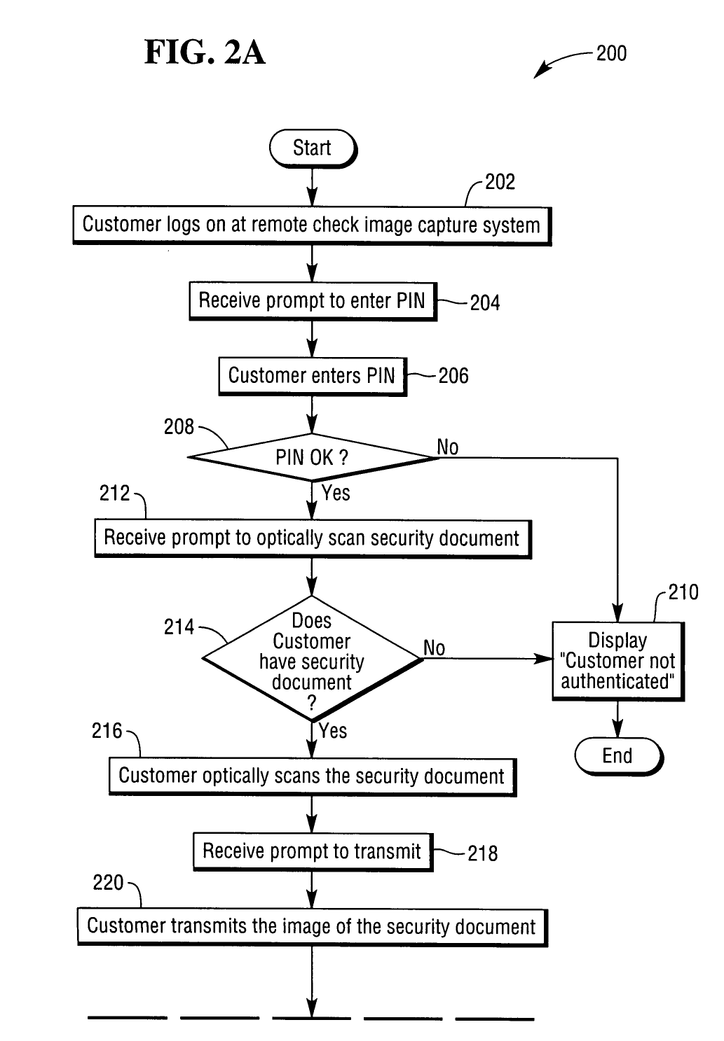

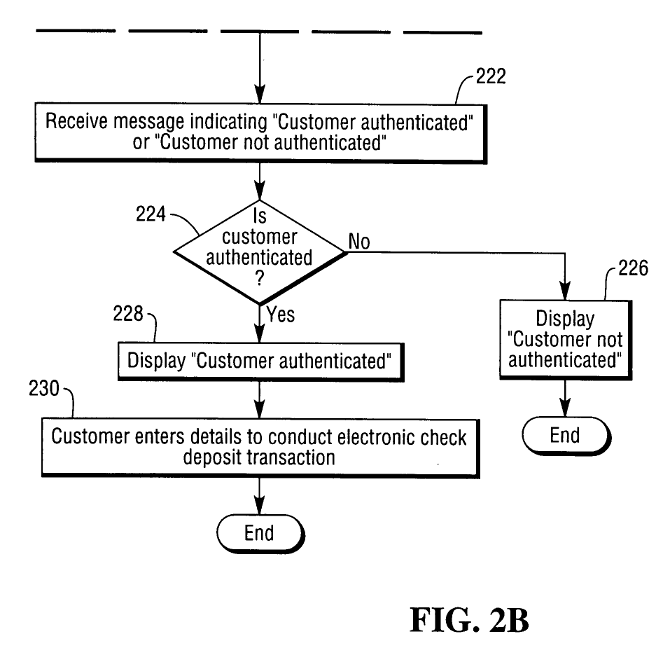

Referring to FIG. 2, a flowchart 200 depicts a process flow of a bank customer 10 desiring to conduct an electronic check deposit transaction. The bank customer is at the location of the remote capture client 12 and the check scanner device 24. In step 202, the bank customer logs onto the remote capture client 12. In step 204, the customer is prompted on a display screen of the remote capture client 12 to enter a personal identification number (“PIN”). The customer then enters a PIN as shown in step 206.

A determination is made in step 208 as to whether the PIN entered by the customer matches information contained in a bank customer database. If the determination in step 208 is negative (i.e., there is not a match), then a message indicating “Customer not authenticated” is displayed on the display screen as shown in step 210. The customer is unable to proceed with conducting an electronic check deposit transaction. However, if the determination in step 208 is affirmative (i.e., there is match), the process proceeds to step 212.

In step 212, the bank customer is prompted on the display screen to scan a physical security document which is in possession of the bank customer. The physical security document may have physical dimensions similar to a standard type of personal check. This makes it relatively easy for the bank customer to keep the security document in a check book or the like. The physical security document contains coded information which can be scanned and lifted by using the check scanner device 24. The coded information on the security document may be in the form of magnetic ink character recognition (MICR) characters located in approximately the location of a MICR codeline of a check.

If the customer does not have a security document, as determined in step 214, then a message indicating “Customer not authenticated” is displayed on the display screen as shown in step 210. The customer is unable to proceed with conducting an electronic check deposit transaction. However, if the customer does have a security document, the customer uses the check scanner device 24 and scans the security document (step 216) to lift the coded information. After the coded information is lifted from the security document, the customer is prompted (step 218) with a message on the display screen to transmit to the bank the coded information which has been lifted from the security document.

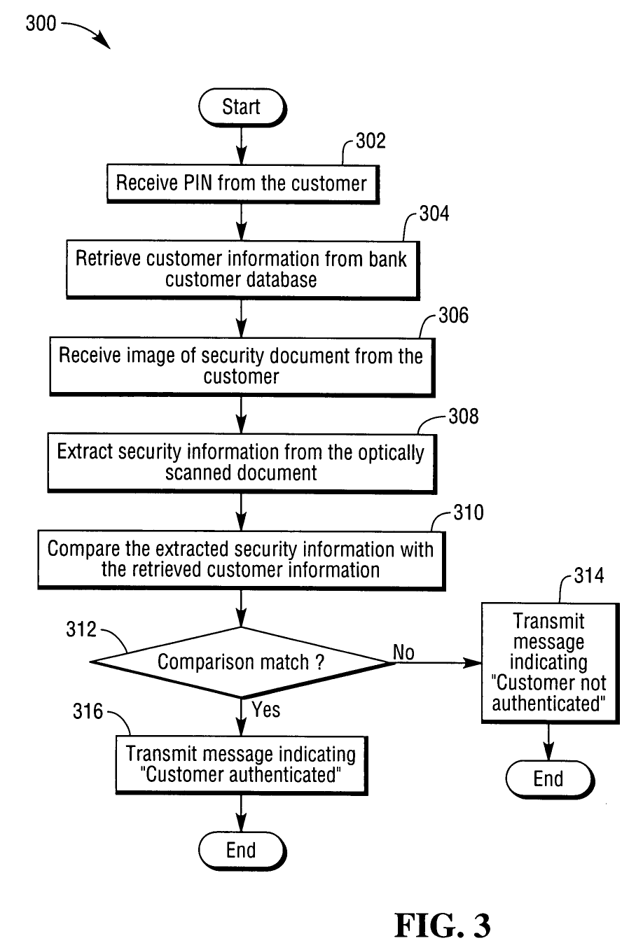

After the customer transmits the coded information to the bank (step 220), the customer waits for the customer authorization program 300 to determine if the customer is authorized to conduct an electronic check deposit transaction (as will be described below in the flowchart of FIG. 3). In step 222, the customer receives a message from the bank to indicate whether the customer is authenticated to conduct an electronic check deposit transaction. If the customer is not authenticated, as determined in step 224, then a message indicating “Customer not authenticated” is displayed on the display screen as shown in step 226. However, if the customer is authenticated, then a message indicating “Customer authenticated” is displayed on the display screen as shown in step 228. After being authenticated, the customer can proceed to conduct an electronic check deposit transaction by providing necessary details as shown in step 230.

Referring to FIG. 3, a flowchart 300 depicts steps performed by the customer authorization program 300. In step 302, the bank server 40 receives the PIN number entered by the customer. As shown in step 304, certain customer information stored in the bank customer database is retrieved based upon the PIN number provided by the customer in step 206 of FIG. 2. In step 306, the bank server 40 receives the image of the security document which has been scanned and transmitted to the bank server by the customer in steps 216 and 220 of FIG. 2. Then, in step 308, the coded information contained in the security document is extracted.

As shown in step 310, the retrieved customer information from step 304 is compared with the coded information which was extracted in step 308. A determination is made in step 312 as to whether the comparison of step 310 provided a match. If the determination in step 312 is negative (i.e., there is no match), then a message indicating “Customer not authenticated” is transmitted to the customer at the remote capture client 12 (step 314). In this case, the customer is not allowed to conduct an electronic check deposit transaction. However, if the determination in step 312 is affirmative (i.e., there is a match), then a message indicating “Customer authenticated” is transmitted to the customer at the remote capture client 12 (step 316). In this case, the customer is allowed to conduct an electronic check deposit transaction.

It should be apparent that the remote check image capture system 10 provides an improved customer authentication process in which two factors of the customer are taken into consideration before allowing the customer to conduct an electronic check deposit transaction. One factor of the customer is what the customer knows (i.e., the PIN), and the other factor is what the customer has (i.e., the security document). Both of these factors of the customer must be verified before the customer is authenticated to allow the customer to conduct an electronic check deposit transaction. If none or only one of these factors is satisfied, then the customer is not authenticated and, therefore, not allowed to conduct an electronic check deposit transaction.

Although the above description describes a PIN in which only numeric characters are typically used, it is conceivable that a secret password with only alphabetic characters may be used. Moreover, it is conceivable that a secret password with any combination of alphanumeric characters may be used.

Also, although the above description describes the security information on the security document as being coded, it is conceivable that the security information on the security document may be uncoded. Further, although the above describes the coded information being in the format of machine-readable MICR characters, it is conceivable that the coded information may be in a different machine-readable format such as a barcode. This helps to prevent fraud.

Although the above description describes the customer authorization program 300 as being located in the server program memory 44, it is conceivable that the program may be located at the client program memory 16, or a combination of both memories. Moreover, it is conceivable that the customer authorization program may be at a location remote from the server program memory 44 or the client program memory 16, or both.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of a bank authenticating a bank customer desiring to electronically deposit at least one check, the method comprising:
receiving a secret password from the bank customer;
retrieving information relating to the bank customer;
receiving an image of a security document which has been optically scanned by the bank customer;
extracting information from the image of the physical security document; and
authenticating the bank customer when both the secret password received from the bank customer and the extracted information from the image of the security document match the retrieved information relating to the bank customer.

2. A method according to claim 1, wherein the extracted information comprises coded information.

3. A method according to claim 1, wherein the extracted information comprises uncoded information.

4. A method according to claim 1, wherein the secret password is received from the bank customer before image of the image of the security document is received from the bank customer.

5. A method according to claim 1, wherein the image of the security document is received from the bank customer before the secret password is received from the bank customer.

6. A method according to claim 1, wherein the image of the security document comprises an image of a check-sized security document.

7. A method of a bank authenticating a bank customer desiring to electronically deposit at least one check, the method comprising:
receiving a personal identification number (PIN) from the bank customer;
retrieving information relating to the bank customer;
receiving an image of a security document which has been optically scanned by the bank customer;
extracting information from the image of the physical security document; and
authenticating the bank customer when both the PIN received from the bank customer and the extracted information from the image of the security document match the retrieved information relating to the bank customer.

8. A method according to claim 7, wherein the extracted information comprises coded information.

9. A method according to claim 7, wherein the extracted information comprises uncoded information.

10. A method according to claim 7, wherein the PIN is received from the bank customer before image of the image of the security document is received from the bank customer.

11. A method according to claim 7, wherein the image of the security document is received from the bank customer before the PIN is received from the bank customer.

12. A method according to claim 7, wherein the image of the security document comprises an image of a check-sized security document.

13. A method of a bank customer conducting an electronic check deposit transaction with a bank, the method comprising:
entering a secret password to log onto a client computer remote from the bank and to allow the bank to retrieve customer information relating to the bank customer;
optically scanning a physical security document to lift an image of the security document;
transmitting the image of the security document to the bank to allow the bank to extract security information from the transmitted image of the security document; and
receiving from the bank a message which authenticates the bank customer when the extracted security information matches the retrieved customer information relating to the bank customer.

14. A method according to claim 13, wherein the extracted information comprises coded information.

15. A method according to claim 13, wherein the extracted information comprises uncoded information.

16. A method according to claim 13, wherein the bank customer enters the secret password before optically scanning the security document.

17. A method according to claim 13, wherein the bank customer optically scans the security document before entering the secret password.
